(19) United States
(12) Patent Application Publication
(10) Pub. No.: US 2004/0171512 A1
(43) Pub. Date: Sep. 2, 2004

(54) Low-foaming detergent compositions

(76) Inventors: Taro Furuta, Osaka (JP); Keisuke Igarashi, Osaka (JP); Yoshihiko Hirata, Osaka (JP)

Correspondence Address: SNELL & WILMER, ONE ARIZONA CENTER, 400 EAST VAN BUREN, PHOENIX, AZ, 850040001

(21) Appl. No.: 10/481,507

(22) PCT Filed: Jun. 26, 2002
(86) PCT No.: PCT/JP02/06457

(30) Foreign Application Priority Data
Jun. 27, 2001 (JP) 2001-195525

(51) Int. Cl. C11D 1/00

(52) U.S. Cl. 510/470; 510/474

(57) ABSTRACT

The objective of the present invention is to provide a biodegradable low-foaming detergent composition having a high washing power across a wide temperature range. A biodegradable low-foaming detergent composition, which comprises a sophorolipid, is provided. The sophorolipid includes a sophorolipid (lactone type) at the ratio of at least 35%. Preferably, the sophorolipid includes a sophorolipid (lactone type) and a sophorolipid (acid type) at a ratio of 35:65 to 90:10. The composition may further comprise a detergent auxiliary component. The detergent auxiliary component is selected from the group consisting of enzyme, oxygen bleaching agent, bleaching activator, alkaline builder, sequestering agent (Ca scavenger), fluid reforming agent, and a neutral inorganic salt.

### TECHNICAL FIELD

The present invention relates to a detergent composition. More specifically, the present invention relates to a detergent composition which is suitable for a washing process which requires a low-foaming property.

### BACKGROUND ART

A surfactant has a hydrophilic group and a lipophilic group in one molecule. Because of its chemical properties, such as, a permeating power, a wetting power, an emulsifying power, a dispersing power, a foaming power, a solubilizing power and the like, surfactants are widely used in many industrial fields. The biggest field of use is the field of the detergents.

In the field of the detergents, a surfactant has been selected and used depending on its purpose of end use. For example, for facial washing, a surfactant having a high foaming power and able to form fine foams, and which is mild to skin is required. For laundry detergents, a surfactant having a high washing power and able to form foam which can be easily removed is required. Further, in view of the aspect of environmental protection which has been recently considered to be important, not only a low toxicity, but also abiological degradability, i.e., an ability to be easily degraded by microorganisms, is becoming one of the important standards for selecting a surfactant.

In the field of the detergent, jet washing has been drawing attentions as a new washing method. The jet washing method utilizes a water pressure to remove dirt from objects to be washed. This method is applied in a dish washing machine. When a conventional surfactant having a high foaming power is a detergent used for the jet washing method, a large amount of generated foam weakens jet water pressure, resulting in an unsatisfactory washing effect. Also, the foams overflow a washing machine or a washing tub, causing trouble in the washing process. Thus, jet washing method requires using a low-foaming surfactant, i.e., a surfactant having a low foaming property.

For performing jet washing, a method of adding an antifoaming agent (typically, a silicone antifoaming agent) was considered. However, a satisfactory result in view of a washing power and an antifoaming power cannot be obtained. Currently, a detergent including a block polymer type nonionic surfactant is mainly used for jet washing. The block polymer type nonionic surfactant includes an ethylene oxide (EO), a propylene oxide (PO) or the like in molecules and has a weak foaming power, i.e., it is a low-foaming surfactant. This has a big drawback in that the biodegradability in the environment is significantly low (Journal of The American Oil Chemists' Society, 65, 1669-1676 (1988)). In order to improve the biodegradability in the environment, a block copolymer with an altered degree of polymerization of the propylene oxide, a block polymer with a modified terminal by alkylation, and the like have been synthesized, but did not solve the problem.

Further, hot water (to 90° C.) is often used in the jet washing. Thus, conventional low-foaming nonionic surfactants have problems in washing power. Specifically, a low-foaming nonionic surfactant generally has a low clouding point that is 40° C. or lower. The low foaming property required for the jet washing is obtained by utilizing the fact that the foaming power is lowered at a temperature higher than the clouding point. Since the washing power is significantly lowered at a temperature higher than the clouding point, there is a constraint in a temperature of washing.

The biosurfactant is a surfactant produced by microorganisms. Generally, the biosurfactant is known that as readily biodegraded, and having a high safety. The biosurfactants have a complicated structure compared to surfactants made by a chemical synthesis (bulky structures, one or more functional groups, chiral centers, or the like). Thus, the biosurfactant may show unique properties as a surfactant, thereby drawing attention as a research material. However, in general, the productivity by microorganisms is low, and there is hardly a biosurfactant provided within manufacturing costs which allow a surfactant supplied as an industrial material (Microbiology and Molecular Biology Review, 61, 47, (1997)). The biosurfactants of which surface-activity and washing power are examined in detail to be used as a detergent include a spiculisporic acid (Yukagaku, 39,1040(1990)), agaricicacid (Journal of Japan Oil Chemists' Society, 42, 493 (1993)), synthesized Corynomycolic acids (Journal of Japan Oil Chemists' Society, 44, 419 (1995)), and the like. However, an examination for using these biosurfactants as detergents has not been fully performed.

A sophorolipid (also referred to as a Sophorose lipid) is a glycolipid type biosurfactant found by Gorin et al. in 1961 (Canadian Journal of Chemistry, 39, 846 (1961)). There are several documents which report production of a sophorolipid by yeast. In general, a sophorolipidis thought to be present in a state of mixture of a molecule having a lactone ring (sophorolipid (lactone type)) and a cleaved-type molecule thereof (sophorolipid (acid type)). Regarding the sophorolipid, use of sophorolipid derivatives as a wetting agent (Yukagaku, 36, 748-753 (1987)) and a gelling agent (Japanese Laid-Open Publication No. 7-17668) in cosmetics, use of a mixed sophorolipid in a quality improvement of wheat products have been reported (Japanese Laid-Open Publication No. 61-205449). However, the sophorolipid has not been fully examined in view of the use as a detergent. There is no report which features a sophorolipid (lactone type) or a sophorolipid (acid type) separately.

There is a demand for a development on an industrial use of a biosurfactant and a biosurfactant which can replace a conventional low-foaming block polymer nonionic surfactant.

### DISCLOSURE OF THE INVENTION

The objective of the present invention is to provide a biodegradable low-foaming detergent composition having a good washing power across a wide temperature range.

The present inventors completed the present invention as a result of diligent studies on elucidating properties of the sophorolipid as a surfactant and its industrial use. The present inventors clarified the properties of the sophorolipid (lactone type) and the sophorolipid (acid type) as a surf actant, respectively, and completed the present invention. The present inventors found that a mixture of the sophorolipid (lactone type) and the sophorolipid (acid type) is a surfactant having a low-foaming property, has a washing power superior to other non-ionic surfactants of a low-foaming property, and exhibits its property even in a temperature range generally used for a jet washing (to 90° C.), and completed the present invention.

The present invention relates to a biodegradable low-foaming detergent composition, the composition comprising a sophorolipid.

Preferably, the sophorolipid includes a sophorolipid (lactone type) at the ratio of at least 35%.

Preferably, the sophorolipid includes a sophorolipid (lactone type) and a sophorolipid (acid type) at a ratio of 35:65 to 90:10.

Preferably, the composition further comprises a detergent auxiliary component.

Preferably, the detergent auxiliary component is selected from the group consisting of enzyme, oxygen bleaching agent, bleaching activator, alkaline builder, sequestering agent (Ca scavenger), fluid reforming agent, and a neutral inorganic salt.

### BRIEF DESCRIPTION OF THE DRAWINGS

FIG. 1 shows test results of comparing a foaming power and a foam stability of a sophorolipid included in the low-foaming detergent composition according to the present invention with those of commercially available synthetic detergents, that is, Nonion A, Nonion B, Nonion C, and Nonion D;

FIG. 2 shows test results of comparing a washing power of the sophorolipid included in the low-foaming detergent composition according to the present invention with that of Nonion A, Nonion B, Nonion C, and Nonion D;

FIG. 3 shows test results of the washing power at 20° C., 40° C., and 60° C. of the sophorolipid included in the low-foaming detergent composition according to the present invention;

FIG. 4 shows test results of the foaming power and the foam stability of the sophorolipids having different ratios of lactone type and acid type;

FIG. 5 shows test results of the washing power of the sophorolipids having different ratios of lactone type and acid type;

FIG. 6 shows a biodegradability of the sophorolipid included in the low-foaming detergent composition according to the present invention;

FIG. 7 shows a result of a dish washing test; and

FIG. 8 shows a structure of the sophorolipid (acid type) and the sophorolipid (lactone type).

### BEST MODE FOR CARRYING OUT THE INVENTION

Hereinafter, the present invention will be described in more detail.

The sophorolipid included in the low-foaming detergent composition according to the present invention has a basic structure comprising a sophorose or a sophorose having a part of a hydroxyl group acetylated, and a hydroxy fatty acid. The sophorolipid is a mixture of a plurality of molecular species divided roughly into a sophorolipid (acid type) which has a free carboxyl group in the hydroxy fatty acid, and a sophorolipid (lactone type) in which the carboxyl group is ester-bonding with a hydroxyl group in a molecule. The mixture includes sophorolipid (lactone type) at a ratio of at least 35%.

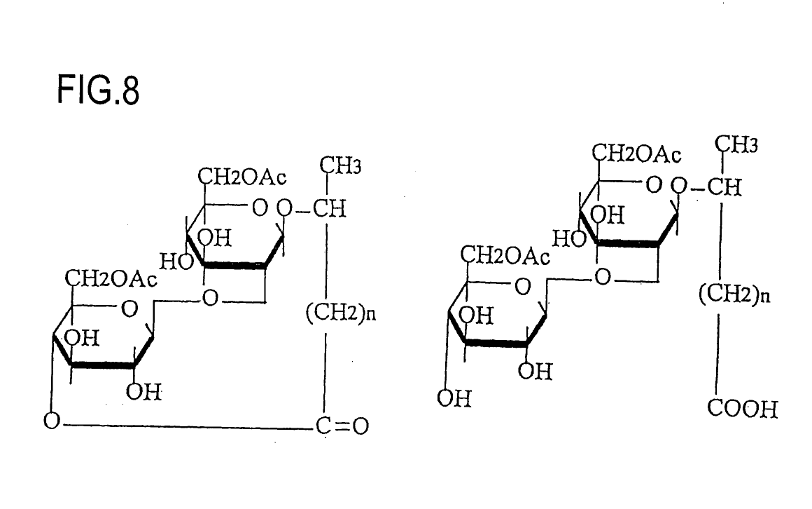

FIG. 8 shows structures of the sophorolipid (acid type) and the sophorolipid (lactone type). The structure shown in the right part of FIG. 8 is the acid type sophorolipid and the structure shown in the left part of FIG. 8 is the lactone type sophorolipid. The term “sophorolipid” as used herein refers to a mixture of the sophorolipid (acid type) and the sophorolipid (lactone type). In FIG. 8, Ac indicates an acetyl group with a hydroxyl group of the sophorose substituted. In general, n is an integer from 11 through 17. The sophorolipid used for the detergent composition according to the present invention typically obtained by yeast fermentation production. The hydroxyl group of the sophorose may exist with a part of it acetylated. The sophorolipid used for the detergent composition according to the present invention may include the sophorolipid (acid type) and the sophorolipid (lactone type) of any structure as long as the sophorolipid exhibits a low-foaming property, a superior washing power, and good biodegradability as defined herein.

The sophorolipid used in the present invention is typically obtained by culturing microorganisms. For example, the sophorolipid is produced by yeast of Candida, such as Candida bombicola, C. apicola, C. petrophilum, C. bogoriensis, and the like. When the yeast of Candida is given a sugar of a high concentration and an oily substrate and cultured, a large amount (100 to 150 g/L) of the sophorolipid is accumulated in a medium (Asmer et al., J. Am. Oil Chem. Soc. 65: 1460-6 (1988), Kozaric et al., J. Am. Oil Chem. Soc. 72: 67-71 (1992), and Japanese Laid-Open Publication No. 6-62877).

Typically, the sophorolipid is isolated from the cultured medium of the above microorganisms by a method of centrifugal separation, decantation, ethyl acetate extraction or the like. By further washing with hexane, the sophorolipid can be obtained as a brown viscous liquid. By selecting a culturing material and culturing conditions, the sophorolipid is precipitated as a crystal during culturing, and with a simple filtering the sophorolipid can be obtained (Journal of Biotechnology, 6, 259 (1987), Applied Microbiology and Biotechnology, 42, 192, (1994)). The culturing and collecting method is not limited to those described above. The sophorolipid used for the present invention can be obtained by any culturing and collecting method known to those skilled in the art.

Preferably, the sophorolipid included in the detergent composition according to the present invention includes the sophorolipid (lactone type) at the ratio of at least 35%. If the content of the sophorolipid (lactone type) in the sophorolipid is smaller than 35%, the foaming power is high and a large amount of foam is formed. Thus, it does not exhibit the properties of the low-foaming surfactant nor does it have a low washing power. If the content of the sophorolipid (lactone type) in the sophorolipid is larger than 90%, it has a sufficient low-foaming property but has low water solubility and washing power, resulting in disadvantages. The symbol “%” as used herein refers to percent by weight unless otherwise noted.

The term “low-foaming property” as used herein means a property showing a foaming power suitable for a washing process which requires a low-foaming property. Specifically, as measured using a Ross Miles method, which is an evaluation method for the foaming power widely conducted at present, a foam height immediately after drop-wise addition should be about 57 mm or less, and a foam height after 5 minutes should be about 30 mm or less. If these foam heights are respectively over about 57 mm and about 30 mm, trouble occurs during the washing using the jet washing method, such that the washing power is lowered by a reduced jet water pressure due to foaming, foam overflows the washing machine, or the like.

The detergent composition according to the present invention exhibits a washing power which is equal to or better than the conventional low-foaming surfactants suitable for a washing process which requires the low-foaming property. This is shown by, for example, performing a washing test using a soiled swatch, which is an evaluation method of washing power widely conducted at present.

The detergent composition according to the present invention has a good biodegradability. The “good biodegradability” as used herein means a good biodegradability shown by a test for evaluating an ultimate biodegradability widely conducted at present. Specifically, a surfactant having a good biodegradability has 50% or more of BOD/ThOD, %, which indicates an ultimate biodegradability, in 28 days. Examples of such a surfactant includes soap, linear alkylbenzene sulfonate (LAS), alkyl sodium sulphate (AS), polyoxyethylenealkyl sodium sulphate (AES), α-olefin sodium sulfonate (AOS), polyoxyethylene alkyl ether (AE), sucrose ester (SE), alkylglycoside (AG), monoalkylphosphate (MAP), and the like.

The detergent composition according to the present invention is a low-foaming surfactant having a superior washing power and a good biodegradability and fulfills all the conditions described above, such as the low foaming property, superior washing power and good biodegradability.

The low-foaming detergent composition according to the present invention may include a sophorolipid (typically, including the sophorolipid (lactone type) and the sophorolipid (acid type) at a ratio of 35:65 to 90:10) as a low-foaming surfactant at a ratio of 0.01 to 20%, preferably 0.1 to 5%, in a detergent composition. If the content of the sophorolipid in the detergent composition is less than 0.01%, a sufficient washing effect cannot be achieved. If the content of the sophorolipid in the detergent composition is larger than 20%, a sufficient washing effect cannot be achieved due to a large amount of foam generated during the jet washing. If the content of the sophorolipid in the detergent composition is larger than 20%, the hygroscopicity of the detergent composition rises and causes disadvantages in an external appearance and a feel of use, caking while being stored, and the like. The low-foaming detergent composition of the present invention is particularly suitable for a washing process which requires a low-foaming property, such as jet washing.

The low-foaming detergent composition according to the present invention may further include detergent auxiliary components in addition to the sophorolipid. As the detergent auxiliary components, any detergent auxiliary component known to those skilled in the art may be used. For example, an enzyme, an oxygen bleaching agent, a bleaching activator, an alkaline builder, a sequestering agent (Ca scavenger), a fluid reforming agent, and neutral inorganic salts, or the like, which is mixed in a detergent composition for use with a dish washing machine which is rapidly coming into wide use, may be used.

Examples of the enzyme include amylase, protease, cellulose, lipase, pullulanase, isopullulanase, isoamylase, catalase, peroxidase, or the like. The enzyme can be added by selecting appropriately in light of its substrate specificity. For example, protease may be selected for a protein stain, and amylase may be selected for a starch stain.

Examples of the oxygen bleaching agent include peroxides which generate hydrogen peroxide in an aqueous solution, such as perborate, percarbonate, persulfate and the like. The oxygen bleaching agent exhibits an anti-microorganism action in addition to a bleaching action. In the case of mixing an enzyme, since an enzyme is deactivated in a bleaching agent containing a chlorine, the oxygen bleaching agent is preferably used. In the case where an enzyme is not mixed, there is no problem in using the bleaching agent containing a chlorine in the low-foaming detergent composition according to the present invention.

The bleaching activator is used for improving a bleaching effect at a low temperature. Tetra acetyl ethylenediamine (TAED), tetraacetylglycoluril (TAGU), diacetyldioxohexahydrotriadine (DADHT), glucose penta acetate (GPA), sodium nonanoyloxybenzenesulfonate (SNOBS) or the like may be preferably used.

The alkaline builder is added in order to improve the washing power by raising the pH value, and enhances an effect of an enzyme or an oxygen bleaching agent. Examples of the alkaline builder include alkali metal salts of carbonate, hydrogen carbonate, silicate, metasilicate, and boric acid.

As the Ca scavenger, an organic chelating agent or a high-molecular weight chelating agent may be used. Examples of the organic chelating agent include nirilotriacetic acid, ethylenediaminetetraacetate, citrate, succinate, polyphosphoric acid, or the like. Examples of the high-molecular weight chelating agent include acrylic acid, methacrylic acid, maleic anhydride, α-hydroxyacrylate, a polymer of itaconic acid, or copolymers thereof.

The neutral inorganic salts include sodium sulfate, potassium sulfate, or the like. The fluid reforming agent is preferably silica powder, but anhydrous silicate or the like may also be used.

The content and the types of the detergent auxiliary components may be appropriately selected by those skilled in the art depending on the intended forms and utilities of the detergent composition. In order to prepare the low-foaming detergent composition, contents of the detergent auxiliary components may be selected depending on the type so as to be 99.99% or less of the low-foaming detergent composition.

### EXAMPLES

The present invention will be described in detail with reference to the examples below. The examples below are merely an illustration of the present invention, and thus, do not limit the present invention.

Evaluation items and test methods conducted in the examples below are as follows.

1. Foaming Power and Foam Stability

The foaming power and the foam stability were measured by the Ross-Miles method, based on JIS K3362. First, in accordance with a preparation method of Synthetic Hard Water described in the AOAC (Association of Official Analytical Chemists) method, a solution is adjusted to have a hardness of 100 ppm of CaCO₃. Then a buffer of Menzel is used to prepare the solution having a pH value of 8.94 (18° C.) (hereinafter referred to as hard water. This hard water has about the same hardness as that of usual tap water). A subject sample is dissolved in the hard water so as to be 0.01%. Thus, test solutions are obtained.

200 ml of each of the test solutions were added dropwise onto surfaces of liquids at temperature conditions of 20° C. or 40° C., from the height of 900 mm taking 30 seconds. The height immediately after the drop-wise addition indicates the foaming power while the height of the foam 5 minutes after indicates the foam stability.

2. Washing Power

A test solution is prepared similarly to the method described in the above section “1. Foaming power and foam stability” except for the concentration of the subject sample being 0.1%. A wet artificially soiled swatch as specified by the Association of Washing Chemistry Foundation is put in 100 ml of the test solution and washed for 20 minutes at a temperature condition of 20° C. (if necessary, 40° C. and 60° C.), with stirring. Reflectances of the soiled swatch before and after the washing were measured by a calorimeter CR-300 (available from Minolta), and the washing power of the test solution is calculated from the following formula as a washing rate.

Washing rate (%)=[(Reflectance of the soiled swatch after washing)−(Reflectance of the soiled swatch before washing)]/[(Reflectance of unsoiled swatch)−(Reflectance of the soiled swatch before washing)]×100.

3. Test on Solubility in Hard Water

The subject sample is added to hard water described in the above section “1. Foaming power and foam stability” (the hardness of 100 ppm and the pH 8.94) so as to have the concentration of 0.01% or 0.1%. The states of solubilizing was judged under the temperature condition of 40° C. and classified into 3 groups: ◯ indicates that it is completely solubilized; Δ indicates that it is slightly solubilized; and X indicates that it is insoluble or become a white turbid material.

4. Biodegradability Test

Activated sludge was collected and cultured in accordance with an OECD (Organization for Economic Co-operation and Development) test guideline 301C modified MITI test (hereinafter, referred to as “OECD method”). The test solutions were added thereto to obtain an oxygen consumed (BOD) at 20° C. using an automatic coulometer (BOD Trak, BOD automatic measurement meter available from HACH Company, US). Then, biodegradability (%) is calculated from a difference with an amount of oxygen of basal respiration using the following formula.

Biodegradability (%)=[BOD−B/TOD]×100

Herein, BOD refers to a biological oxygen demand (ppm) of the specimen, B refers to an amount of oxygen consumed (ppm) in a blank test, and TOD refers to a theoretical oxygen demand (ppm) when the subject sample material is completely oxidized.

5. Dish Washing Test

Using a domestic dish washing machine (EW-CS5 available from Mitsubishi Electric Corporation), washing power of the detergent composition to the dirt on glasses; bowls; cups; large plates and spoons; middle-sized plates, knives and forks; small plates, knives and forks; rice bowls; and chopsticks were evaluated.

Dirt was prepared on the above dishes as follows and left for one hour. Using thus contaminated dishes, washing power test was performed in a standard course as described in an instruction manual of the dish washing machine, in accordance with a method specified by the Center for Better Living. The number of dishes used is as described in the instruction manual of the washing machine and 9 g of the detergent composition was used. The washing power of the test solution is ranked by a visual examination. The ratio of a judged rank is evaluated by calculating with the following evaluation formula:

{Σa ×(the number of dishes)+Σb×(the number of dishes)+Σc×(the number of dishes))/the total number of dishes×2.

TABLE 1
Visual examination method

| | Conditions after | | |
|---|---|---|---|
| Rank | washing | Dish surface | Dish back surface |
| a | Completely no | No contaminant | A few fine particles |
| | contaminant | attached. | remain. |
| | attached. | | |
| b | Contaminant | A few fine particles | Fine particles |
| | attached, but is | remain. | attached. |
| | not a problem in | | |
| | practical usage. | | |
| c | A large contaminant | A lot of fine | Contaminant in the |
| | attached, | particles. | original form, for |
| | or need | Contaminant in | example, a grain of |
| | another washing. | the original | rice, attached. |
| | | form, for example, | Fine contaminants |
| | | a grain of | attached across a |
| | | rice, attached. | back surface. |

(Preparation of Dirt)

Glasses

Half the standard number of glasses which can be set to be handled by one washing process in the dish washing machine were contaminated with tomato juice and the other half were contaminated with milk. Tomato juice or milk was poured into a glass to fill about 80 to 90% of the volume thereof. The tomato juice and the milk were transferred to a next glass sequentially. The glass from which the tomato juice or the milk was transferred to the next glass was left for about 30 minutes. Then, the glass was turned down for about 5 seconds, and returned to its normal position and left for another 30 minutes.

Bowls

Miso soup containing seaweed was poured into the standard number of bowls which can be set to fill about 70 to 80% of the volume thereof. The bowls were left for about 10 minutes to confirm that miso has sunk in the bowls. The soup were tipped out of the bowls so as to leave some miso grains in the bottoms of the bowls. Then, 3 slices of chopped green onions were put into each of the bowls.

Cups

Commercially available green tea was poured into the standard number of cups which can be set to fill about 70 to 80% of the volume thereof. The cups were left for 20 to 30 minutes. Then, the green tea was tipped out slowly so as to leave a slight tea scum.

Large Plates and Spoons

Commercially available retort packed curry, rice, and raw eggs are mixed with a spoon so as to be uniform. A spoonful of the curry rice is put on each of the standard number of the plates which can be set and the center parts of the plates are contaminated in a similar manner. Then, the curry rice was removed with about ten grains of rice left on a surface of the plate. Peripheral portions of the plates were wiped with tissue paper. The spoons were left upside down on a plate with a grain of rice on each of the surface and the back.

Middle-sized Plates, Knives and Forks

Pork cutlets bought from the store were heated and cut into an appropriate size. Then, they were distributed to the standard number of plates which can be set, and, with sauce put thereon, they were cut into smaller pieces with a knife and a fork. Thus, surfaces of the plates were uniformly contaminated with oil from the pork cutlets and sauce. After the pork cutlets were removed, peripheral portions of the plates were wiped with tissue paper. The knives and the forks were again contaminated with the removed pork cutlets so as to form an oil film on the surfaces thereof.

Small Plates, Knives and Forks

Soft-boiled ham and eggs were cooked. They were equally distributed to the standard number of the plates which can be set. The plates were contaminated by cutting the ham and eggs with the same knives and forks used for cutting the pork cutlets above. Large pieces of the ham and eggs were removed and the knives and the forks were uniformly contaminated with the left overs.

Rice Bowls

Rice was put into the standard number of rice bowls which can be set. The rice was stirred with chopsticks and removed with about three grains of rice remaining in the inner walls of the rice bowls.

Chopsticks

The chopsticks were contaminated by sticking them in and pulling them out of the rice ten times with each one of the chopsticks having a grain of the rice attached.

### (Example 1) Low-foaming Property of Sophorolipid

Foaming power and foam stabilities of sophorolipid (the ratio of lactone type to acid type is about 7 to 3) obtained by yeast fermentation production, a block polymer type nonionic surfactant, and a commercial synthetic detergent were compared in accordance with the test method in the above section “1. Foaming power and foam stability”, under the conditions that CaCO₃ is 100 ppm and the pH value is 8.94 (18° C.).

As the block polymer type nonionic surfactants, Nonions A, B, C and D including polyoxyethylene were used. Nonion A is a New Pole PE61 (Sanyo Chemical Industries, Ltd.) being PO-EO block copolymer (Pluronic). Nonions B through D are polyoxyethylenepolyoxyalkylene ethers having different degrees of polymerization of PO and EO. Softanol EP 7045 (Nippon Shokubai Co., Ltd.) was used as Nonion B. Plurafac LF431 (BASF) was used as Nonion C. Conion AEP1220 (New Japan Chemical Co., Ltd.) was used as Nonion D. The commercial synthetic detergent was used as a control sample of foaming power (having a high foaming power).

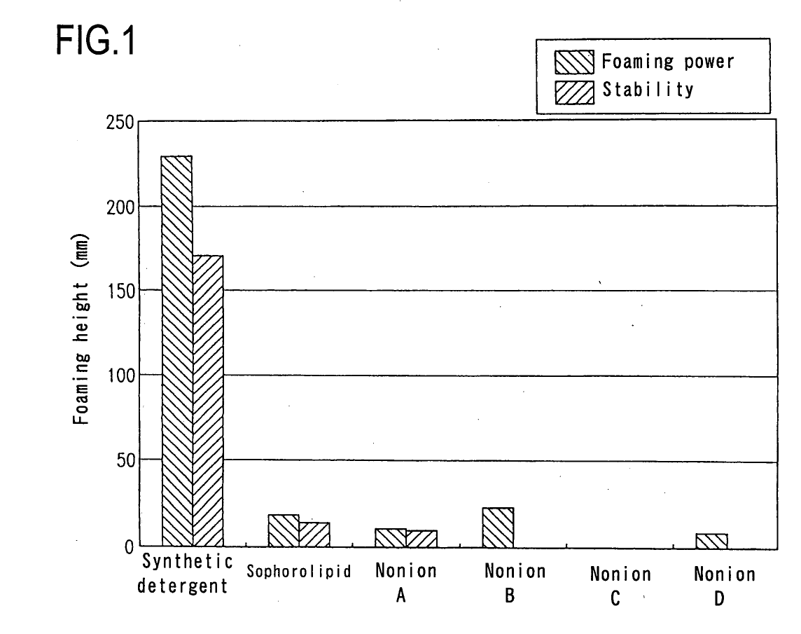

The result is shown in FIG. 1. As shown in FIG. 1, the foaming power (about 17 mm, represented by a bar shaded with oblique lines inclining down to the right-hand side) and the foam stability (about 10 mm, represented by a bar shaded with oblique lines inclining up to the right-hand side) of the sophorolipid are respectively equal to or less than one tenth of the foaming power (about 230 mm) and the foam stability (about 170 mm) of the commercial synthetic detergent. It also became apparent that the foaming power and the foam stability of the sophorolipid are not inferior to the foaming power (0 to about 23 mm) and the foam stability (O to about 10 mm) of other low-foaming block polymer nonionic surfactants. Based on these results, the sophorolipid proved to have the properties of a low-foaming surfactant.

### Example 2

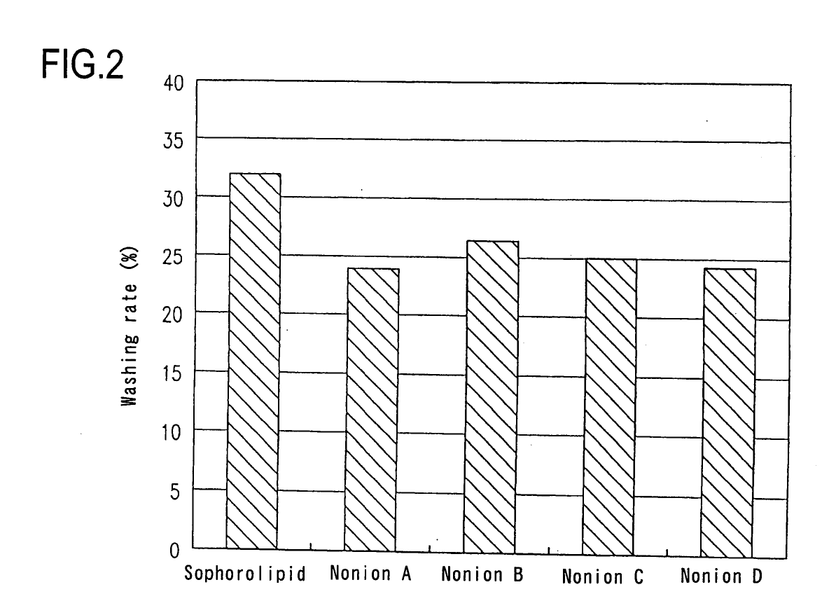

With the test method as described in the above section “2. Washing power”, the washing power of the sophorolipid (the ratio of lactone type to acid type is about 7 to 3) obtained by yeast fermentation production was examined. The results are shown in FIG. 2. In FIG. 2, the horizontal axis shows the subject samples and the vertical axis shows a washing rate (%) calculated by the formula shown in the above section “2. Washing power”. As shown in FIG. 2, the sophorolipid exhibits the washing rate of about 33%, which is higher than the washing rates of the block copolymer type nonionic surfactants (about 24 to 27%).

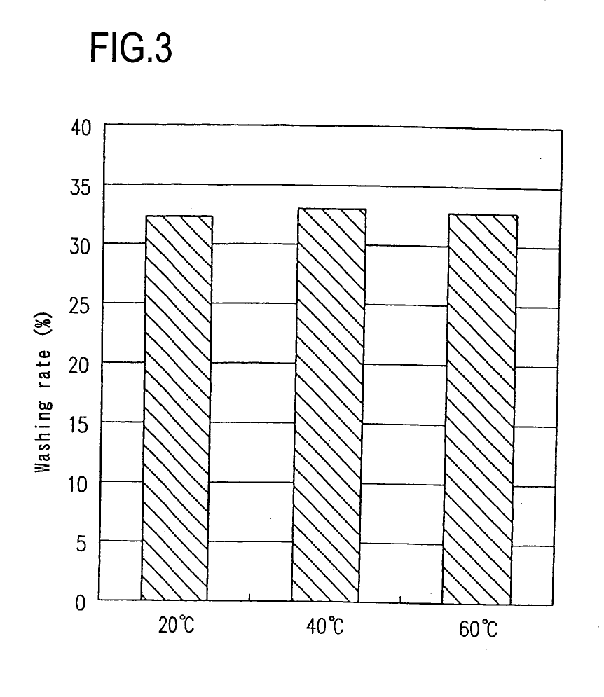

The washing rate of the sophorolipid was not lowered at 40° C. (about 32%) and at 60° C. (about 33%) (FIG. 3).

### Example 3

### Foaming Power and Foam Stability, Washing Power, and Test on Solubility in Hard Water of Mixtures of Sophorolipid (Acid Type) and Sophorolipid (Lactone Type)

The sophorolipid obtained by yeast fermentation production was separated into the sophorolipid (acid type) and the sophorolipid (lactone type) using an ion-exchange resin (Demiace DX-Y50 (available from Kurita Water Industries)). Alternately, the sophorolipid (acid type) and the sophorolipid (lactone type) were separated by solvent extraction, if necessary. In this case, the sophorolipid obtained by fermentation is mixed with water of an amount twice as much. The mixture was prepared to have a pH value of 7.0 with NaOH. The mixture was extracted with an equal amount of ethyl acetate for ten times or more. By evaporating an ethyl acetate phase, the sophorolipid (lactone type) was obtained. Then, the water phase including the sophorolipid (acid type) was prepared to have a pH value 3 with HCl. The mixture was extracted with an equal amount of ethyl acetate for three times or more. The ethyl acetate phase including the sophorolipid (acid type) was separated and condensed with an evaporator to obtain the sophorolipid (acid type).

The acid-type obtained and the sophorolipid (lactone type) were mixed in various ratios and the above-described “1. Foaming power and foam stability”, “2. Washing power”, and “3. Test on solubility in hard water” were performed.

The confirmation of acid-type and lactone type were performed by HPLC. Nucleosil 5SB packed column (4.6×250 mm) of Macherey-Nagel (Germany) was used. With 0.2% (w/v) of sodium perchlorate/methanol solution as a mobile phase, and the separation was performed under the conditions where a column temperature is 35° C. and a flow rate is 1 ml/minute. Detection was performed using a refractive index detector (RID).

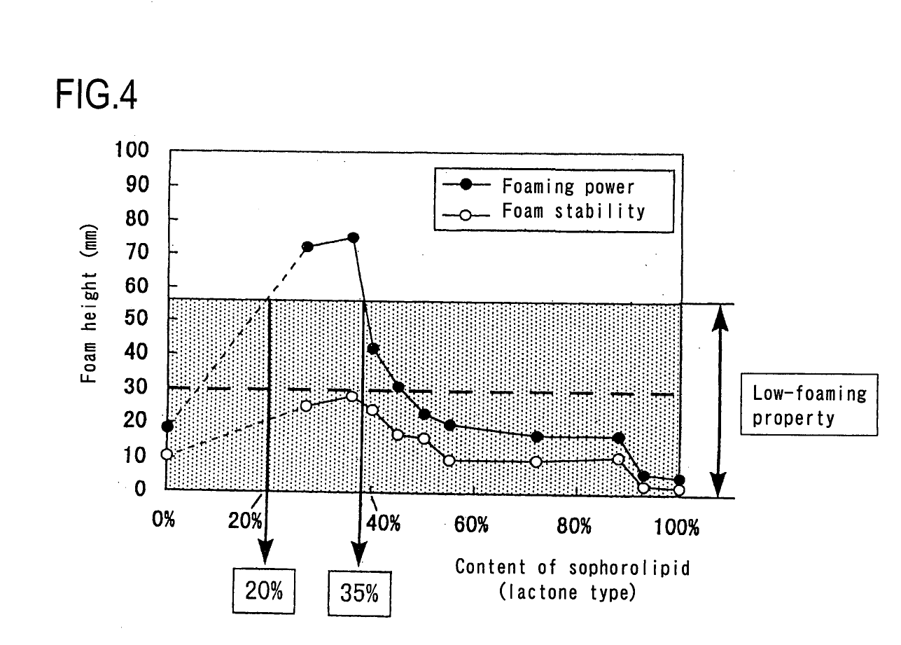

FIG. 4 shows results of tests of foaming power (represented by filled circles) and foam stability (represented by unfilled circles). The measurement was performed at 40° C. In FIG. 4, the horizontal axis indicates ratio of the sophorolipid (lactone type) included in the sophorolipid, and the vertical axis indicates foam heights (foaming power). As shown in FIG. 4, it became apparent that the sophorolipid has the low-foaming property (the foaming power is 57 mm or less and the foam stability is about 30 mm or lower) when the content of the sophorolipid (lactone type) is within the range of 0 to about 20%, and about 35 to 100%. In other words, it became apparent that the sophorolipidhaving the ratio of the sophorolipid (lactone type): the sophorolipid (acid type) within 0:100 to 20:80 and 35:65 to 100:0 has a satisfactory low-foaming property. Also as shown in FIG. 4, the sophorolipid having the ratio of the sophorolipid (lactone type):the sophorolipid (acid type) is within 50:50 to 88:12 has the foaming power of about 20 mm and the foam stability of about 10 mm. Thus, such a sophorolipid has particularly good properties as a low-foaming surfactant.

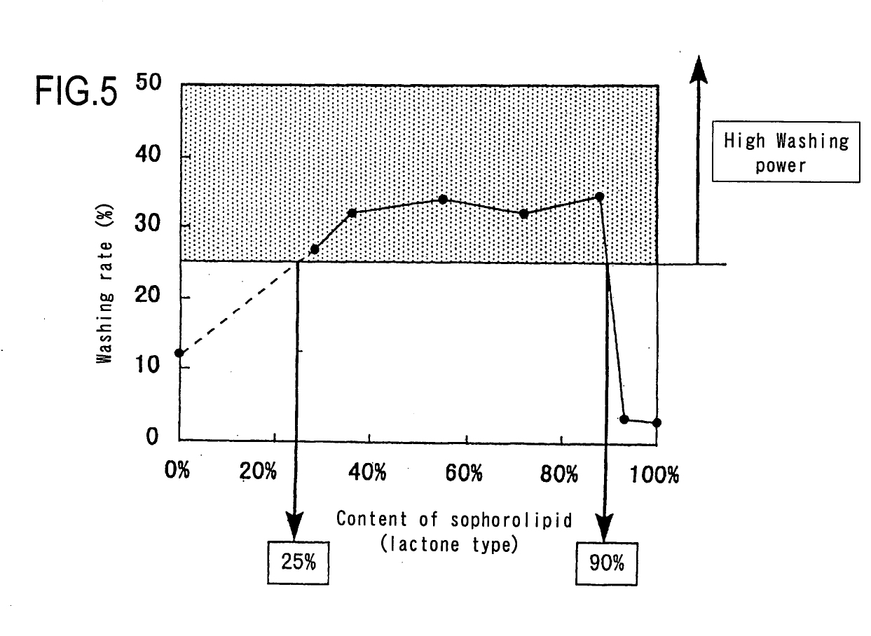

FIG. 5 shows results of the test described in section“2.Washing power”. In FIG. 5, the horizontal axis indicates a ratio of the sophorolipid (lactone type) included in the sophorolipid and the vertical axis indicates a calculated washing power (%).

As shown in FIG. 5, the sophorolipid having the content of the sophorolipid (lactone type) within the range of about 25 to 90% shows washing power of 25% or more. In other words, the sophorolipid has a high washing power when the ratio of the sophorolipid (lactone type):sophorolipid (acid type) is within the range of 25:75 to 90:10. Also as shown in FIG. 5, when the ratio of the sophorolipid (lactone type) :sophorolipid (acid type) is within the range of 30:70 to 88:12, the sophorolipid exhibits washing power of 30% or more, thereby showing an excellent washing power.

Table 2 shows results of a test of the above section “3. Test on solubility in hard water”. As shown in Table 2, it became apparent that the sophorolipid having the content of the sophorolipid (lactone type) across the wide range of about 27 to 90% is soluble. Further, when the content of the sophorolipid (lactone type) is 0%, i.e., the sophorolipids are all acid type, it became a white turbid material in hard water. Further, when the content of the sophorolipid (lactone type) is 0%, i e., the sophorolipids are all sophorolipid (acid type), it became a white turbid material in hard water of 100 ppm of CaCO₃. When the content of the sophorolipid (lactone type) is about 93% or more, the sophorolipids are dispersed and became a white turbid material. In Table 2, the SL is an abbreviation of the sophorolipid.

TABLE 2
The relationship between the lactone type content of the
sophorolipid and the solubility

| SL | Lactone type content (%) | | | | | | | | | | |
|---|---|---|---|---|---|---|---|---|---|---|---|
| concentration | 0 | 27 | 36 | 40 | 45 | 55 | 72 | 88 | 90 | 93 | 100 |
| 0.01% | X | ◯ | ◯ | ◯ | ◯ | ◯ | ◯ | ◯ | Δ | X | X |
| 0.10% | X | ◯ | ◯ | ◯ | ◯ | ◯ | ◯ | Δ | Δ | X | X |

◯: completely solubilized
Δ: slightly solubilized
X: insoluble or cause a white turbid material

Based on the results of Example 1. and Example 2, the sophorolipid which fulfills the three requirements of low-foaming property, excellent washing power and solubility includes the sophorolipid (lact one type) and the sophorolipid (acid type) in the ratio in the range-of 35:65 to 90:10. Particularly, it became apparent that the sophorolipid having the ratio of the sophorolipid (lact one type) : the sophorolipid (acid type) within the range of 50: 50 to 88:12 has low-foaming property and a high washing power.

### Example 4

### Biodegradability Test of Sophorolipid

Using the sophorolipid (the ratio of lactone type to acid type is about 7 to 3) obtained by yeast fermentation production as a subject sample, the biodegradability was calculated by a method described in the above section “4. Biodegradability test”. Soap (coconut oil potash soap), Nonion A, and polyoxyethylenealkylether (AE: Emulgen 108KM (Kao Corporation) were used as control samples.

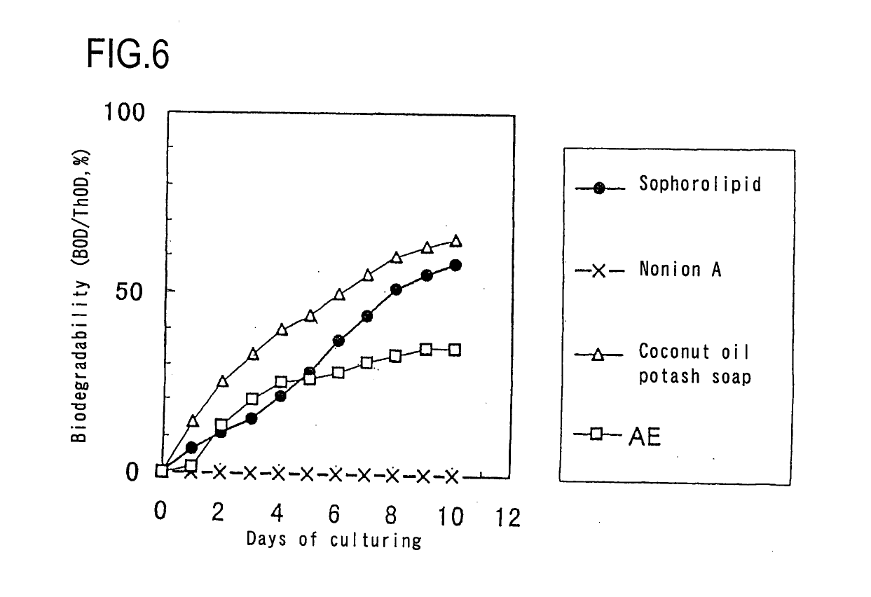

The results are shown in FIG. 6. As shown in FIG. 6, the biodegradability (%) of the sophorolipid (indicated by filled circles) is increased as culturing proceeds. On the tenth day of the culturing, about 58% of the sophorolipid was degraded. This rate is not inferior to that of the soap, which is a surfactant which can be easily degraded (indicated by unfilled triangles, about 65% of the soap was degraded on the tenth day of the culturing) and having a better degradability than AE (indicated by unfilled squares, about 35% of the soap was degraded on the tenth day of the culturing). Further, it became apparent that biodegradabilities (%) of the block polymer type nonionic surfactants (indicated by X) remained almost zero and are difficult to be degraded.

### Example 5

### Dish Washing Test (Comparison Between the Sophorolipid Composition, Block Polymer type Nonionic Activator-mixed Detergent and Soap-mixed Detergent)

Low-foaming detergent compositions 1-11 having constitutions indicated in Table 3 were prepared.

TABLE 3
Low-foaming detergent composition with which washing tests
were performed

| | Composition wt % | | | | | | | | | | |
|---|---|---|---|---|---|---|---|---|---|---|---|
| | 1 | 2 | 3 | 4 | 5 | 6 | 7 | 8 | 9 | 10 | 11 |
| Nonion A *1 | 1 | 0 | 0 | 0 | 0 | 0 | 0 | 0 | 0 | 0 | 0 |
| Nonion B *2 | 0 | 1 | 0 | 0 | 0 | 0 | 0 | 0 | 0 | 0 | 0 |
| Nonion C *3 | 0 | 0 | 1 | 0 | 0 | 0 | 0 | 0 | 0 | 0 | 0 |
| Nonion D *4 | 0 | 0 | 0 | 1 | 0 | 0 | 0 | 0 | 0 | 0 | 0 |
| Soap | 0 | 0 | 0 | 0 | 5 | 0 | 0 | 0 | 0 | 0 | 0 |
| Sophorolipid | 0 | 0 | 0 | 0 | 0 | 0.001 | 0.01 | 0.1 | 5 | 20 | 25 |
| Sodium percarbonate | 10 | 10 | 10 | 10 | 10 | 10 | 10 | 10 | 10 | 10 | 10 |
| Trisodium citrate | 10 | 10 | 10 | 10 | 10 | 10 | 10 | 10 | 10 | 10 | 10 |
| Proteolytic enzyme *5 | 1 | 1 | 1 | 1 | 1 | 1 | 1 | 1 | 1 | 1 | 1 |
| Starch lytic enzyme *6 | 1 | 1 | 1 | 1 | 1 | 1 | 1 | 1 | 1 | 1 | 1 |
| Fluid reforming agent | 1 | 1 | 1 | 1 | 1 | 1 | 1 | 1 | 5 | 8 | 10 |
| Sodium carbonate | 25 | 25 | 25 | 25 | 25 | 25 | 25 | 25 | 25 | 25 | 25 |

Sodium sulfate: balance
*1: New Pole PE61 (Sanyo Chemical Industries, Ltd.)
*2: Softanol EP 7045 (Nippon Shokubai Co., Ltd.)
*3: Plurafac LF431 (BASF)
*4: Conion AEP1220 (New Japan Chemical Co., Ltd.)
*5: Savinase 6.0T (Novo Nordisk)
*6: Duramyl 60T (Novo Nordisk)

The sophorolipid in the table is the sophorolipid (the ratio of lactone type to acid type is about 7 to 3) obtained by yeast fermentation production. The soap in the table is a sodium salt of fatty acid containing 99% soap constituents. Dish washing property of each of the compositions was tested by the method described in the above section “5. Dish washing test”.

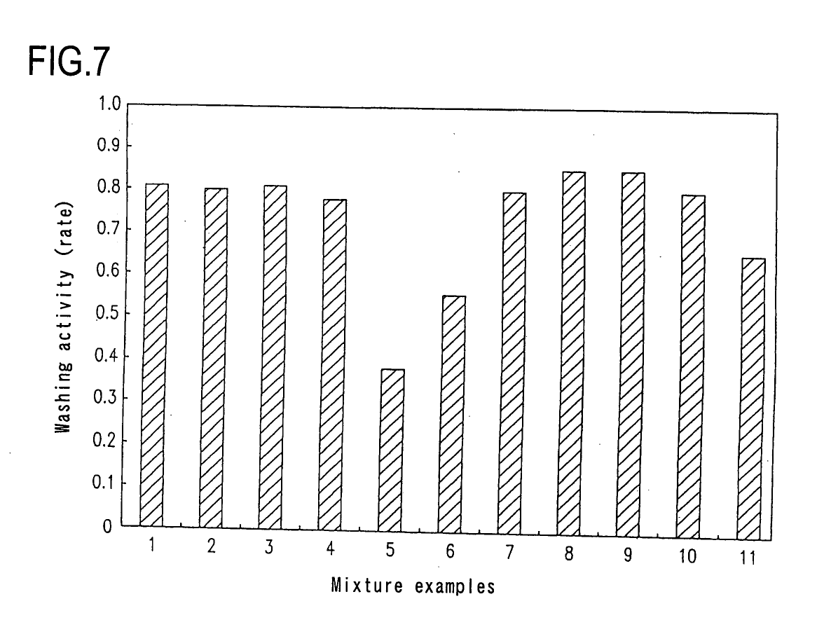

The results are shown in FIG. 7. As shown in FIG. 7, the sophorolipid-mixed detergent compositions (mixture examples 7 to 10) exhibited washing rates of 0.8 to 0.85, which are equal to or greater than the compositions in which the block polymer type nonionic surfactant is mixed (mixture examples 1 to 4, washing rate was 0.78 to 0.81). Also, it became apparent that the sophorolipid-mixed detergent compositions have washing power better than that of mixture example 5 in which soap is mixed (washing rate is 0.38). With the rate of the contents of the sophorolipids changed to 0.001, 0.01, 0.1, 5, 20 and 25% (mixture examples 6 to 11), it became apparent that when the content of the sophorolipids is within the range of 0.01 to 20%, the composition has a high washing rate. A composition having the content of sophorolipid of 0.01% or lower has the slightly lowered washing power. A composition having the content of sophorolipid of 20% or more forms a large amount of foam and the washing power rate is lowered.

### Industrial Applicability

A biodegradable low-foaming detergent composition maintaining a high washing power across a wide temperature range is provided.

1. A biodegradable low-foaming detergent composition comprising a sophorolipid.

2. A composition according to claim 1, wherein the sophorolipid includes a sophorolipid (lactone type) at the ratio of at least 35%.

3. A composition according to claim 1, wherein the sophorolipid includes a sophorolipid (lactone type) and a sophorolipid (acid type) at a ratio of 35:65 to 90:10.

4. A composition according to any of claims 1 through 3, further comprising a detergent auxiliary component.

5. A composition according to claim 4, wherein the detergent auxiliary component is selected from the group consisting of enzyme, oxygen bleaching agent, bleaching activator, alkaline builder, sequestering agent (Ca scavenger), fluid reforming agent, a neutral inorganic salt.
